(19) United States
(12) Patent Application Publication
(10) Pub. No.: US 2005/0173647 A1
(43) Pub. Date: Aug. 11, 2005

(54) Radiation detector assembly, lithographic apparatus, method of determining an amount of radiation, an intensity of the amount of radiation, or an amount of contamination of an optical element, device manufacturing method, and device manufactured thereby

(75) Inventor: Levinus Pieter Bakker, Helmond (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 10/981,766

(22) Filed: Nov. 5, 2004

(30) Foreign Application Priority Data
Nov. 7, 2003 (EP) 03078516.6

(51) Int. Cl. G03C 5/00

(52) U.S. Cl. 250/372

(57) ABSTRACT

A radiation detector assembly includes an optical element including a substrate and a partially reflective optical layer. The optical element is configured to receive an amount of radiation when the assembly is in use and reflect a first portion of the amount of radiation and transmit a second portion of the amount of radiation through the optical layer and the substrate. A radiation detector is configured to receive the second portion of the amount of radiation and provide a measurement signal. A measurement system is configured to receive the measurement signal from the radiation detector and derive from the measurement signal the amount of radiation, an intensity of the amount of radiation, or an amount of contamination of the optical layer.

### CROSS REFERENCE TO RELATED APPLICATIONS

This application claims priority to European Patent Application 03078516.6, filed Nov. 7, 2003, the contents of which are incorporated herein by reference.

### BACKGROUND OF THE INVENTION

1. Field of the Invention

The present invention relates to a radiation detector assembly, a lithographic apparatus, a method of determining an amount of radiation, an intensity of the amount of radiation, or an amount of contamination of an optical element receiving the amount of radiation, a device manufacturing method, and a device manufacture thereby.

2. Description of the Related Art

A lithographic apparatus is a machine that applies a desired pattern onto a target portion of a substrate. Lithographic apparatus can be used, for example, in the manufacture of integrated circuits (ICs). In that circumstance, a patterning device, such as a mask, may be used to generate a circuit pattern corresponding to an individual layer of the IC, and this pattern can be imaged onto a target portion (e.g. including part of one or several dies) on a substrate (e.g. a silicon wafer) that has a layer of radiation-sensitive material (resist). In general, a single substrate will contain a network of adjacent target portions that are successively exposed. Known lithographic apparatus include steppers, in which each target portion is irradiated by exposing an entire pattern onto the target portion at once, and scanners, in which each target portion is irradiated by scanning the pattern through the beam of radiation in a given direction (the “scanning” direction) while synchronously scanning the substrate parallel or anti-parallel to this direction.

From US 2003/0052275 A1 an EUV radiation flux detector whose calibration does not fluctuate is known. The idea presented in US 2003/0052275 A1 is to embed an integral EUV photodiode behind a multilayer reflection stack. Between the photodiode and the multilayer reflection stack a planarizing layer is present. The planarizing layer serves two functions, first it defines a micro-fine surface suitable for the growth of the multilayer reflection stack, and second it provides an insulating layer between the multilayer reflection stack and its surroundings. As the detector from US 2003/0052275 A1 is relatively insensitive to changes in environmental conditions, for example contamination of the surface of the sensor, it can not be used to obtain an idea of the contamination on the surface of an optical component.

U.S. patent application Publication 2004/0106068 A1, in the name of the applicant, incorporated herein by reference, describes a sensor that detects emitted radiation from the surface of a reflector. The emitted radiation is generated when electrons, that are excited into a higher energy state by an incident beam of radiation on the surface, return to a lower energy state. During this process, a part of the incident radiation will also be converted into heat. The emitted radiation will have a longer wavelength than the incident radiation. The emitted radiation is also called luminescent radiation. The sensor is positioned in front of the reflector.

Measuring the EUV radiation flux in a lithographic apparatus is done to improve performance. Radiation flux is the radiation energy per unit time per unit area in J/sec/m². Information on the EUV radiation flux is needed to determine EUV dose and intensity and to determine the amount of contamination on optical components. Since EUV radiation losses should be kept as low as possible, it is important that an EUV radiation flux detector blocks an EUV beam of radiation as little as possible. Prior art techniques for measuring the EUV radiation flux measure scattered EUV radiation or, both or alternatively, used the “surplus” radiation of a beam of radiation i.e. the part of the beam of radiation that is not used for lithographic purposes to determine the EUV radiation flux. These techniques, unfortunately, can not be employed at every position in a lithographic apparatus. Presently, the secondary electron flux emitted from an optical component while irradiated with EUV radiation is used as a measure for the EUV radiation flux. However, there are several problems in connection with this technique. For example, the presence of electric fields is required. These electric fields accelerate positive ions towards an optical component, which results in unwanted sputtering of such an optical component. Also, due to the high electron current, the secondary electron flux is a non-linear function of the EUV radiation flux. It is presently an open question whether detection of EUV radiation flux by measuring the secondary electron flux is possible at all.

### SUMMARY OF THE INVENTION

It is an aspect of the present invention to provide an assembly for determining EUV radiation flux in a lithographic projection apparatus more conveniently and more reliable and at more optical components than is presently possible.

According to an embodiment of the present invention, a radiation detector assembly includes an optical element including a substrate and a partially reflective optical layer, the optical element being configured to receive an amount of radiation when the assembly is in use and reflect a first portion of the amount of radiation and transmit a second portion of the amount of radiation through the optical layer and the substrate; a radiation detector configured to receive the second portion of the amount of radiation and provide a measurement signal; and a measurement system configured to receive the measurement signal from the radiation detector and derive from the measurement signal the amount of radiation, an intensity of the amount of radiation, or an amount of contamination of the optical layer, or any combination thereof

The present invention provides for detection of the amount or intensity of the radiation by use of the not useful radiation (e.g. radiation that is not reflected and would otherwise be lost). No electric field is necessary, no changes are necessary to optical components presently available in a lithographic projection apparatus, and no additional light sources are required. Measured signals are a linear function of EUV dose. A layer that at least partly converts the radiation fraction from a second wavelength to a first wavelength may be a fluorescent layer. Such a layer is relatively easy to produce in comparison to, for example, a large photodiode. In addition, spatially resolved radiation measurements are possible with such a layer. Radiation dose and intensity and the amount of contamination on the surface of an optical component, are parameters in a lithographic apparatus. An optical component generally includes an optical layer (or coating) deposited on a substrate. In particular for EUV radiation, a problem is that the substrate, though required to support the optical layer, is a radiation absorber. By converting the EUV radiation to radiation for which the substrate is relatively transparent, this problem is also solved by the present invention.

In further embodiments, the converting layer is a host lattice and at least one ion, and the host lattice includes at least one of calcium sulfide (CaS), zinc sulfide (ZnS) and yttrium aluminum garnet (YAG) and the ion includes at least one of Ce³⁺, Ag⁺ and Al³⁺. These materials have proven to be particularly suited for layers that have to convert radiation. These materials convert EUV radiation to radiation with a longer wavelength and with a relatively high efficiency.

In a further embodiment, the detector includes a CCD camera, a CMOS sensor, or a photodiode array. The previous enumeration is not limited nor complete and alternative detectors may be used. These detectors provide position dependent measurements.

In still a further embodiment, the optical component includes a multilayer stack. These types of mirrors, for example including alternating layers of molybdenum (Mo) and silicon (Si), are frequently encountered in lithographic projection apparatus working with a EUV radiation source.

In still a further embodiment, the second type of radiation includes at least one of EUV and IR radiation. For these types of radiation some substrates are substantially transparent, which means that these types may be used.

In yet another embodiment, a radiation source is configured to provide a measurement beam towards the optical component, a detector is configured to receive at least a portion of the measurement beam after the measurement beam has passed through the optical component and a measurement system is connected to the detector to receive a measurement signal determine an amount of contamination of the surface from the measurement signal. This assembly provides measurements insensitive to variations in the radiation source of the lithographic apparatus.

The invention also relates to a lithographic apparatus including an illumination system configured to provide a beam of radiation of radiation; a support configured to support a patterning device, the patterning device configured to impart the beam of radiation with a pattern in its cross-section; a substrate table configured to hold a substrate; a projection system configured to project the patterned beam onto a target portion of the substrate; and a radiation detector assembly as described above.

The invention also relates to a method of determining an amount of radiation received by an optical component, an intensity of the amount of radiation received by the optical component, or an amount of contamination of a partially reflective optical layer of the optical element, the method including reflecting a first portion of the amount of radiation and transmitting a second portion of the amount of radiation; detecting the second portion of the amount of radiation; and determining the amount of radiation, the intensity of the amount of radiation, or the contamination of the optical layer from the detected second portion, or any combination thereof.

The invention also relates a device manufacturing method including providing a beam of radiation; patterning the beam of radiation with a pattern in its cross-section; projecting the beam of radiation after it has been patterned onto a target portion of the substrate; receiving the beam of radiation with an optical component including a partially reflective optical layer; and determining a dose of the beam of radiation received by an optical component, an intensity of the amount of radiation received by the optical component, or an amount of contamination of a partially reflective optical layer of the optical element by reflecting a first portion of the beam of radiation and transmitting a second portion of the beam of radiation; detecting the second portion of the beam of radiation; and determining the dose of the beam of radiation, the intensity of the beam of radiation, or the amount of contamination of the optical layer from the detected second portion, or any combination thereof.

Although specific reference may be made in this text to the use of lithographic apparatus in the manufacture of ICs, it should be appreciated that the lithographic apparatus described herein may have other applications, such as the manufacture of integrated optical systems, guidance and detection patterns for magnetic domain memories, liquid-crystal displays (LCDs), thin-film magnetic heads, etc. It should be appreciated that, in the context of such alternative applications, any use of the terms “wafer” or “die” herein may be considered as synonymous with the more general terms “substrate” or “target portion”, respectively. The substrate referred to herein may be processed, before or after exposure, in, for example, a track (a tool that typically applies a layer of resist to a substrate and develops the exposed resist) or a metrology or inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g. having a wavelength of 365, 248, 193, 157 or 126 nm) and extreme ultra-violet (EUV) radiation (e.g. having a wavelength in the range of 5-20 nm), as well as particle beams, such as ion beams or electron beams.

The term “patterning device” used herein should be broadly interpreted as referring to a device that can be used to impart a beam of radiation with a pattern in its cross-section such as to create a pattern in a target portion of the substrate. It should be noted that the pattern imparted to the beam of radiation may not exactly correspond to the desired pattern in the target portion of the substrate. Generally, the pattern imparted to the beam of radiation will correspond to a particular functional layer in a device being created in the target portion, such as an integrated circuit.

Patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions; in this manner, the reflected beam is patterned. In each example of patterning device, the support structure may be a frame or table, for example, which may be fixed or movable as required and which may ensure that the patterning device is at a desired position, for example with respect to the projection system. Any use of the terms “reticle” or “mask” herein may be considered synonymous with the more general term “patterning device”.

The term “projection system” used herein should be broadly interpreted as encompassing various types of projection system, including refractive optical systems, reflective optical systems, and catadioptric optical systems, as appropriate for example for the exposure radiation being used, or for other factors such as the use of an immersion fluid or the use of a vacuum. Any use of the term “lens” herein may be considered as synonymous with the more general term “projection system”.

The illumination system may also encompass various types of optical components, including refractive, reflective, and catadioptric optical components for directing, shaping, or controlling the beam of radiation of radiation, and such components may also be referred to below, collectively or singularly, as a “lens.”

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein the substrate is immersed in a liquid having a relatively high refractive index, e.g. water, so as to fill a space between the final element of the projection system and the substrate. Immersion liquids may also be applied to other spaces in the lithographic apparatus, for example, between the mask and the first element of the projection system. Immersion techniques are well known in the art for increasing the numerical aperture of projection systems.

### BRIEF DESCRIPTIONS OF THE DRAWINGS

Embodiments of the present invention will now be described, by way of example only, with reference to the accompanying schematic drawings in which corresponding reference symbols indicate corresponding parts, and in which:

FIG. 1 depicts a lithographic apparatus according to an embodiment of the present invention;

FIG. 2 depicts a radiation detector assembly according to the present invention;

FIG. 3 depicts a radiation detector assembly according to another embodiment of the present invention;

FIG. 4 depicts a radiation detector assembly according to yet another embodiment of the present invention;

FIGS. 5a and 5b show two transmission graphs for a multilayer stack with and without the presence of a carbon layer; and

FIG. 6 shows a transmission ratio calculated on the basis of FIG. 5a.

### DETAILED DESCRIPTION

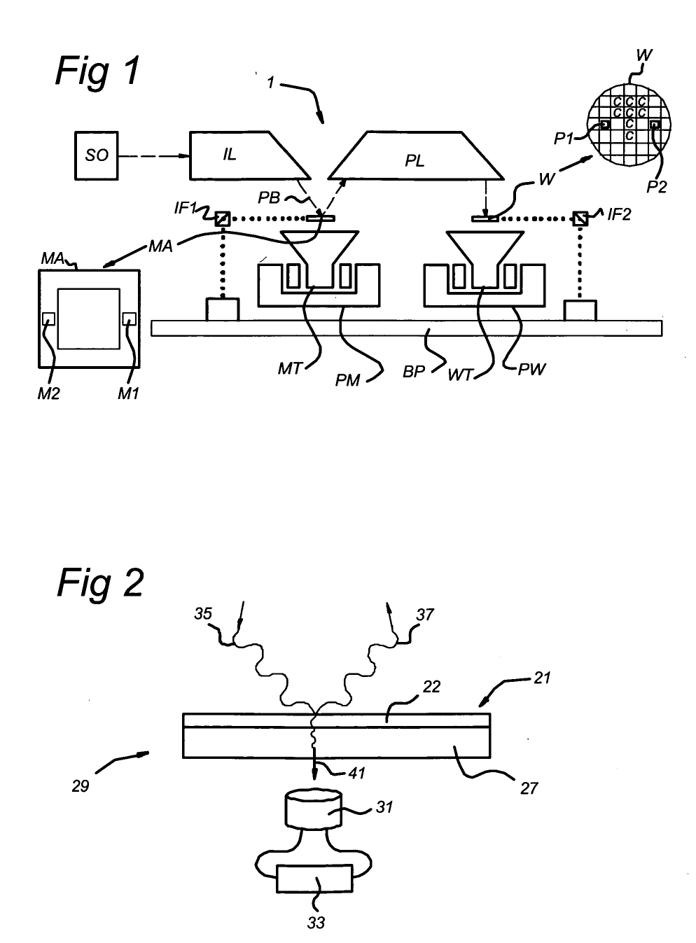

FIG. 1 schematically depicts a lithographic apparatus 1 according to an embodiment of the invention. The apparatus includes a base plate BP. An illumination system (illuminator) IL is configured to provide a beam of radiation PB of radiation (e.g. UV or EUV radiation). A support (e.g. a mask table) MT is configured to support a patterning device (e.g. a mask) MA and is connected to a first positioning device PM that accurately positions the patterning device with respect to a projection system PL. A substrate table (e.g. a wafer table) WT is configured to hold a substrate (e.g. a resist-coated wafer) W and is connected to a second positioning device PW that accurately positions the substrate with respect to the projection system PL. The projection system (e.g. a reflective projection lens) PL is configured to image a pattern imparted to the beam of radiation PB by patterning device MA onto a target portion C (e.g. including one or more dies) of the substrate W.

As here depicted, the apparatus is of a reflective type (e.g. employing a reflective mask or a programmable mirror array of a type as referred to above). Alternatively, the apparatus may be of a transmissive type (e.g. employing a transmissive mask).

The illuminator IL receives radiation from a radiation source SO. The source and the lithographic apparatus 1 may be separate entities, for example when the source is a plasma discharge source. In such cases, the source is not considered to form part of the lithographic apparatus and the radiation is generally passed from the source SO to the illuminator IL with the aid of a radiation collector including, for example, suitable collecting mirrors and/or a spectral purity filter. In other cases the source may be integral part of the apparatus, for example when the source is a mercury lamp. The source SO and the illuminator IL may be referred to as a radiation system.

The illuminator IL may include an adjusting device(s) to adjust the angular intensity distribution of the beam. Generally, at least the outer and/or inner radial extent (commonly referred to as σ-outer and σ-inner, respectively) of the intensity distribution in a pupil plane of the illuminator can be adjusted. The illuminator provides a conditioned beam of radiation PB having a desired uniformity and intensity distribution in its cross-section.

The beam of radiation PB is incident on the mask MA, which is held on the mask table MT. Being reflected by the mask MA, the beam of radiation PB passes through the projection system PL, which focuses the beam onto a target portion C of the substrate W. With the aid of the second positioning device PW and position sensor IF2 (e.g. an interferometric device), the substrate table WT can be moved accurately, e.g. so as to position different target portions C in the path of the beam PB. Similarly, the first positioning device PM and position sensor IF1 (e.g. an interferometric device) can be used to accurately position the mask MA with respect to the path of the beam PB, e.g. after mechanical retrieval from a mask library, or during a scan. In general, movement of the object tables MT and WT will be realized with the aid of a long-stroke module (coarse positioning) and a short-stroke module (fine positioning), which form part of the positioning devices PM and PW. However, in the case of a stepper, as opposed to a scanner, the mask table MT may be connected to a short stroke actuator only, or may be fixed. Mask MA and substrate W may be aligned using mask alignment marks M1, M2 and substrate alignment marks P1, P2.

The depicted apparatus can be used in the following preferred modes:
1. In step mode, the mask table MT and the substrate table WT are kept essentially stationary, while an entire pattern imparted to the beam of radiation is projected onto a target portion C at once (i.e. a single static exposure). The substrate table WT is then shifted in the X and/or Y direction so that a different target portion C can be exposed. In step mode, the maximum size of the exposure field limits the size of the target portion C imaged in a single static exposure.
2. In scan mode, the mask table MT and the substrate table WT are scanned synchronously while a pattern imparted to the beam of radiation is projected onto a target portion C (i.e. a single dynamic exposure). The velocity and direction of the substrate table WT relative to the mask table MT is determined by the (de-)magnification and image reversal characteristics of the projection system PL. In scan mode, the maximum size of the exposure field limits the width (in the non-scanning direction) of the target portion in a single dynamic exposure, whereas the length of the scanning motion determines the height (in the scanning direction) of the target portion.
3. In another mode, the mask table MT is kept essentially stationary holding a programmable patterning device, and the substrate table WT is moved or scanned while a pattern imparted to the beam of radiation is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

A measurement assembly 29 according to an embodiment of the present invention is shown in FIG. 2. In FIG. 2 an optical component 21 is shown. The optical component 21, having an optical layer 22 deposited on a substrate 27, may typically be a lens as described above or a mirror (e.g. a multilayer mirror), a reticle, etc. The present invention is suited for optical components with a reflective optical layer 22. Radiation 35 from an EUV radiation source (not shown in FIG. 2) is incident on the optical component 21. Some of the radiation is transmitted through the optical component 21 as indicated by reference numeral 41. The larger part of the radiation 35, however, is reflected by the optical layer 22 of the optical component 21 as indicated by reference numeral 37. A detector 31 is present in the vicinity of the optical layer 22 of the optical component 21 as long as it does not block the radiation 35 and/or 37. The detector 31 is connected to a measurement system 33 receiving a signal form the detector 31. The measurement system 33 may be a suitably programmed computer or a measurement arrangement with suitable analogue and/or digital circuits. The substrate 27 must be substantially transparent to the radiation 35. A 200 nm thick silicon (Si) layer may be used for this purpose. Note that the optical component 21 as shown in FIG. 2 includes at least the optical layer 22 deposited on the substrate 27.

The present invention functions in the following way. Although reflection of EUV radiation 35 by the optical component 21 is maximized, there will always be a certain fraction 41 of the EUV radiation 35 that passes through the optical layer 22 and the component 21. This radiation fraction 41 hits the detector 31. Upon incidence of the radiation fraction 41, the detector 31 generates a measurement signal to the measurement system 33. The measurement signal is an indication of changes in EUV dose on optical layer 22 and/or intensity and/or of contamination on optical layer 22. If there are no changes in the measurement signal one may assume that both the dose and the contamination have not been changed. If the measurement signal changes abruptly, one may assume that this is due to abrupt dose changes. However, slow changes of the measurement signal may indicate increasing contamination of the optical layer 22. Moreover, several mirrors in the apparatus may be provided with a sensor behind them, thus providing the option to send more measurement signals to measurement system 33. The measurement system 33, may then be arranged to evaluate all these signals and to conclude about changes of dose and/or contamination based on several measurements. Both absolute, after appropriate gauging, and relative measurements of radiation flux are possible, “relative” meaning the difference in the amount of radiation detected at a moment t1 and the amount of radiation detected at a moment t2, from which it is possible to derive data on contamination/dose and intensity. Also (EUV) radiation sensing measurements in general (e.g. alignment, further optical properties) are possible. In this embodiment the substrate 27 is transparent to the radiation 41 (35).

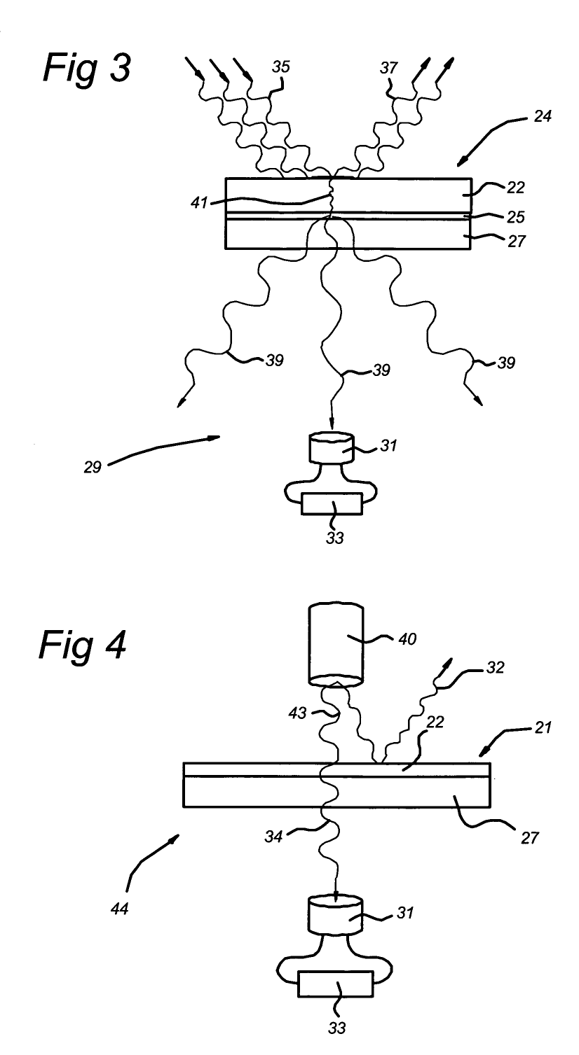

In FIG. 3, another embodiment of the present invention is shown. The same reference numerals apply as previously used in FIG. 2. By contrast with FIG. 2, the optical component in FIG. 3 is referred to with reference numeral 24. In addition, a fluorescent layer 25 is present on the substrate 27. The fluorescent layer 25 can also be incorporated into the substrate 27, for example using an yttrium aluminum garnet (YAG) crystal as a substrate. The optical layer 22 is deposited on the fluorescent layer 25. The radiation emerging from the fluorescent layer 25 is referred to with reference numeral 39. The substrate 27 must be substantially transparent to this radiation 39. As is disclosed in U.S. Pat. No. 6,721,389, the fluorescent layer 25 includes a host lattice and at least one ion. The host lattice may include at least one of calcium sulfide (CaS), zinc sulfide (ZnS) and yttrium aluminum garnet (YAG). The ion may include at least one of Ce³⁺, Ag⁺ and Al³⁺. Note that the optical component 24 as shown in FIG. 3 includes, by contrast to the optical component 21 shown in FIG. 2, at least an optical layer 22 deposited on a substrate 27 and a fluorescent layer 25 deposited in between.

This embodiment functions in the following way. Part 37 of the radiation 35 is reflected by the optical layer 22 of the optical component 24. A fraction of the radiation 35, referred to with 41, passes through the optical component 24 and hits the fluorescent layer 25. The fluorescent layer 25 converts the radiation 41 into radiation 39 that, at least partly, impinges on the detector 31. It is to be noted that the conversion does not necessarily imply a 100% (or close to 100%) conversion. Generally speaking, the wavelength of the radiation 39 will be different from the wavelength of the radiation 35, 37 and/or 41. It should be appreciated that the substrate 27 must be substantially transparent to the radiation 39. The detector 31 is designed to measure the amount of radiation 39. This radiation is correlated to the amount of radiation 35 by several conversion factors. If these conversion factors are known, the amount of radiation 35 can be determined. The fluorescent layer 25 may be large. Such a layer is relatively easy to produce in comparison to, for example, a large photodiode. In addition, spatially resolved radiation measurements are possible with such a layer. In this embodiment the substrate 27 is transparent to radiation 39.

In FIG. 4, a further embodiment of the present invention is shown. In FIG. 4, in which the same reference numerals are used as in FIGS. 2 and 3, a separate radiation source 40, such as a laser, is used in the measurement assembly 44. The radiation source 40 provides a measurement beam 43. A first portion 34 of the measurement beam 43 will pass through the, optical component 21. A second portion 32 will be reflected. By “separate” it is to be understood here that whereas the measurements in FIGS. 2 and 3 are carried out “on line” (i.e. during operation of the lithographic projection apparatus) and use the beam of radiation PB present in the lithographic projection apparatus, the radiation source 40 will be used for measurement purposes only. Depending on the wavelength of the measurement beam 43 provided by the radiation from source 40 and the amount of interference between the beam of radiation PB and the measurement beam 43 from the radiation source 40 (or in fact between the beam of radiation PB and the first portion 34 of the measurement beam 43) both “on line” and “off line” measurements may be done. The measurement beam 43 by the radiation source 40 may typically include radiation generated by a laser (such as a low power Nd:YAG laser) or another infra red (IR) radiation source. This embodiment can be used to accurately scan an optical component. Further benefits include an “independent” contamination measurement (i.e. a contamination measurement that is not blurred/disturbed by a dose measurement).

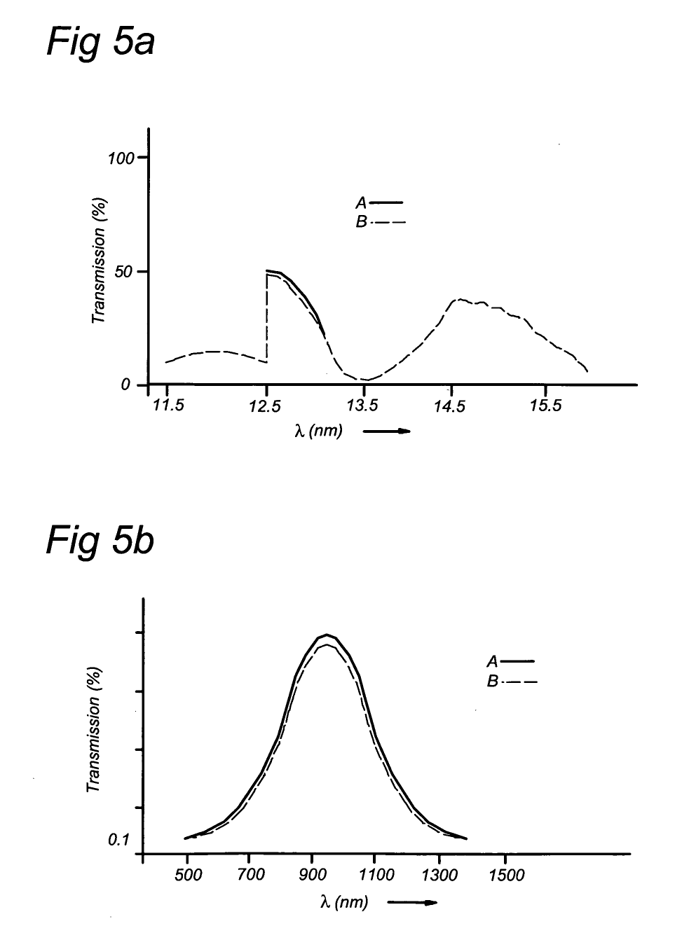

In this embodiment, use is made of the fact that in the transmission spectrum of a multilayer stack there are wavelength intervals where the stack is relatively transparent. One of these intervals is located around 13.5 nm (in the EUV range of the electromagnetic spectrum) and one interval is located around 1000 nm (in the IR range of the electromagnetic spectrum). This will be appreciated from the accompanying FIGS. 5a and 5a. In this embodiment the substrate 27 is transparent to radiation 34 (43). Although here the explanation is directed to an optical component 21 similar to the optical component shown in FIG. 2, it should be appreciated that this embodiment may be combined with an optical component 24 as shown in FIG. 3, without substantially departing from the scope of the present invention.

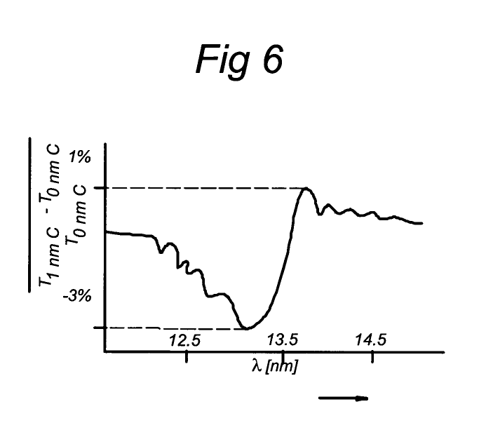

FIGS. 5a and 5b show the calculated transmission for 40 bi-layers of 2.5 nm Mo and 4.4 nm Si. Radiation around these ranges is relatively easily transmitted through the stack as shown by graph A in FIGS. 5a and 5b. The transmission is affected by a contaminating 1 nm thick layer of carbon (C) on the multilayer stack (graph B). Contaminant particles, such as hydrocarbon molecules and water vapor, are present in lithographic projection apparatus. These contaminant particles may include debris and by-products that are sputtered loose from the substrate, for example by an EUV radiation beam. The particles may also include debris from the EUV source, contaminants liberated at actuators, conduit cables, etc. Since parts of lithographic projection apparatus, such as the radiation system and the projection system, are generally at least partially evacuated, these contaminant particles tend to migrate to such areas. The particles then adsorb to the surfaces of the optical components located in these areas. This contamination of the optical components causes a loss of reflectivity, which may adversely affect the accuracy and efficiency of the apparatus, and may also degrade the components' surfaces, thus reducing their useful lifetime. Although not clearly visible from FIG. 5a (due to the small differences compared to the scale of the drawing) the transmission is always different i.e. more or less without or with the 1 nm layer of carbon. The ratio (the transmission with a layer of 1 nm carbon minus the transmission without a layer of 1 nm carbon)/(the transmission without a layer of 1 nm carbon) may vary between +1% and −3%. This ratio is shown in FIG. 6. By detecting the radiation through the multilayer stack the intensity/dose and or contamination on the stack can be derived. In other words, if one measures the transmission of radiation through the multilayer, an estimate of the amount of carbon contamination may be obtained. The transmission of the radiation is wavelength dependent.

While specific embodiments of the invention have been described above, it will be appreciated that the invention may be practiced otherwise than as described. For example, in the embodiment of FIG. 4 the optical component 21 may be provided with a substrate 27 and a fluorescent layer 25 also. The description is not intended to limit the invention.

1. A radiation detector assembly, comprising:
an optical element including a substrate and a partially reflective optical layer, the optical element being configured to receive an amount of radiation when the assembly is in use and reflect a first portion of the amount of radiation and transmit a second portion of the amount of radiation through the optical layer and the substrate;
a radiation detector configured to receive the second portion of the amount of radiation and provide a measurement signal; and
a measurement system configured to receive the measurement signal from the radiation detector and derive from the measurement signal the amount of radiation, or an intensity of the amount of radiation, or an amount of contamination of the optical layer, or any combination thereof.

2. An assembly according to claim 1, further comprising an intermediate layer between the substrate and the partially reflective optical layer, wherein the amount of radiation received by the optical element is a first type of radiation, the intermediate layer converts at least part of the second portion of the amount of radiation from the first type of radiation to a second type of radiation, the radiation detector is configured to detect the second type of radiation, and the measurement system is configured to correlate the measurement signal of the second type of radiation to the amount of the first type of radiation, or the intensity of the amount of the first type of radiation, or the amount of contamination of the optical layer, or any combination thereof.

3. An assembly according to claim 2, wherein the intermediate layer comprises a host lattice and at least one ion.

4. An assembly according to claim 3, wherein the host lattice comprises calcium sulfide (CaS), zinc sulfide (ZnS) or yttrium aluminum garnet (YAG) and the ion compreses Ce³⁺, Ag⁺ or Al³⁺.

5. An assembly according to claim 1, wherein the intermediate layer comprises a fluorescent layer.

6. An assembly according to claim 1, wherein the radiation detector comprises a CCD camera, a CMOS sensor, or a photodiode array.

7. An assembly according to claim 1, wherein the optical component comprises a multilayer stack.

8. An assembly according to claim 7, wherein the multilayer stack includes a layer of silicon (Si) and a layer of molybdenum (Mo).

9. An assembly according to claim 2, wherein the second type of radiation comprises EUV or IR radiation.

10. An assembly according to claim 1, further comprising a radiation source configured to provide a measurement beam of radiation, wherein the optical element is configured to receive the measurement beam of radiation and reflect a first portion of the measurement beam of radiation and transmit a second portion of the measurement beam of radiation through the optical layer and the substrate, the radiation detector is configured to receive the second portion of the measurement beam of radiation and provide a second measurement signal, and the measurement system is configured to receive the second measurement signal from the radiation detector and derive from the second measurement signal the amount of contamination of the optical layer.

11. An assembly according to claim 10, wherein the radiation source is configured to provide the measurement beam of radiation with a wavelength in the infra red (IR) part or the ultra violet (UV) part of the electromagnetic spectrum.

12. A lithographic apparatus, comprising an illumination system configured to providing a beam of radiation;
a support configured to support a patterning device, the patterning device configured to impart the beam of radiation with a pattern in its cross-section;
a substrate table configured to holding a substrate;
a projection system configured to project the patterned beam onto a target portion of the substrate; and
a radiation detector assembly comprising
an optical element including a substrate and a partially reflective optical layer, the optical element being configured to receive the beam of radiation when the assembly is in use and reflect a first portion of the beam of radiation and transmit a second portion of the beam of radiation through the optical layer and the substrate;
a radiation detector configured to receive the second portion of the beam of radiation and provide a measurement signal; and
a measurement system configured to receive the measurement signal from the radiation detector and derive from the measurement signal a dose of the beam of radiation, or an intensity of the beam of radiation, or an amount of contamination of the optical layer, or any combination thereof.

13. An apparatus according to claim 12, further comprising an intermediate layer between the substrate and the partially reflective optical layer, wherein the beam of radiation received by the optical element is a first type of radiation, the intermediate layer converts at least part of the second portion of the beam of radiation from the first type of radiation to a second type of radiation, the radiation detector is configured to detect the second type of radiation, and the measurement system is configured to correlate the measurement signal of the second type of radiation to the dose of the beam of radiation, or the intensity of the beam of radiation, or the amount of contamination of the optical layer, or any combination thereof.

14. An apparatus according to claim 13, wherein the intermediate layer comprises a host lattice and at least one ion.

15. An apparatus according to claim 14, wherein the host lattice comprises calcium sulfide (CaS), zinc sulfide (ZnS) or yttrium aluminum garnet (YAG) and the ion compreses Ce³⁺, Ag⁺ or Al³⁺.

16. An apparatus according to claim 12, wherein the intermediate layer comprises a fluorescent layer.

17. An apparatus according to claim 12, wherein the radiation detector comprises a CCD camera, a CMOS sensor, or a photodiode array.

18. An apparatus according to claim 12, wherein the optical component comprises a multilayer stack.

19. An apparatus according to claim 18, wherein the multilayer stack includes a layer of silicon (Si) and a layer of molybdenum (Mo).

20. An apparatus according to claim 13, wherein the second type of radiation comprises EUV or IR radiation.

21. An apparatus according to claim 12, further comprising a radiation source configured to provide a measurement beam of radiation, wherein the optical element is configured to receive the measurement beam of radiation and reflect a first portion of the measurement beam of radiation and transmit a second portion of the measurement beam of radiation through the optical layer and the substrate, the radiation detector is configured to receive the second portion of the measurement beam of radiation and provide a second measurement signal, and the measurement system is configured to receive the second measurement signal from the radiation detector and derive from the second measurement signal the amount of contamination of the optical layer.

22. An apparatus according to claim 21, wherein the radiation source is configured to provide the measurement beam of radiation with a wavelength in the infra red (IR) part or the ultra violet (UV) part of the electromagnetic spectrum.

23. A method of determining an amount of radiation received by an optical component, an intensity of the amount of radiation received by the optical component, or an amount of contamination of a partially reflective optical layer of the optical element, the method comprising:
reflecting a first portion of the amount of radiation and transmitting a second portion of the amount of radiation;
detecting the second portion of the amount of radiation; and
determining the amount of radiation, or the intensity of the amount of radiation, or the contamination of the optical layer from the detected second portion, or any combination thereof.

24. A method according to claim 23, wherein the amount of radiation is a first type of radiation and the method further comprises:
converting at least part of the second portion to a second type of radiation; and
correlating the detected second type of radiation to the amount of the first type of radiation, or the intensity of the amount of the first type of radiation, or the amount of contamination of the optical layer, or any combination thereof.

25. A device manufacturing method, comprising:
providing a beam of radiation;
patterning the beam of radiation with a pattern in its cross-section; and
projecting the beam of radiation after it has been patterned onto a target portion of the substrate;
receiving the beam of radiation with an optical component including a partially reflective optical layer; and
determining a dose of the beam of radiation received by an optical component, or an intensity of the amount of radiation received by the optical component, or an amount of contamination of a partially reflective optical layer of the optical element, or any combination thereof, by
reflecting a first portion of the beam of radiation and transmitting a second portion of the beam of radiation;
detecting the second portion of the beam of radiation; and
determining the dose of the beam of radiation, or the intensity of the beam of radiation, or the amount of contamination of the optical layer from the detected second portion, or any combination thereof.

26. A device manufactured according to the method of claim 25.

27. A radiation detector assembly, comprising:
an optical element comprising
a substrate;
a partially reflective optical layer, the optical element being configured to receive radiation of a first type when the assembly is in use and reflect a first portion of the fist type of radiation and transmit a second portion of the first type of radiation through the optical layer and the substrate; and
an intermediate layer configured to receive the second portion of the first type of radiation and convert at least part of the second portion of the first type of radiation to a second type of radiation;
a radiation detector configured to receive the second type of radiation and provide a measurement signal; and
a measurement system configured to receive the measurement signal from the radiation detector and derive from the measurement signal an amount of the first type of radiation, or an intensity of the first type of radiation, or an amount of contamination of the optical layer, or any combination thereof.

28. An assembly according to claim 27, wherein the intermediate layer comprises a host lattice and at least one ion.

29. An assembly according to claim 28, wherein the host lattice comprises calcium sulfide (CaS), zinc sulfide (ZnS) or yttrium aluminum garnet (YAG) and the ion compreses Ce³⁺, Ag⁺ or Al³⁺.

30. An assembly according to claim 27, wherein the intermediate layer comprises a fluorescent layer.

31. An assembly according to claim 27, wherein the radiation detector comprises a CCD camera, a CMOS sensor, or a photodiode array.

32. An assembly according to claim 27, wherein the optical component comprises a multilayer stack.

33. An assembly according to claim 32, wherein the multilayer stack includes a layer of silicon (Si) and a layer of molybdenum (Mo).

34. An assembly according to claim 27, wherein the second type of radiation comprises EUV or IR radiation.
